(19) United States
(12) Patent Application Publication
(10) Pub. No.: US 2017/0076322 A1
(43) Pub. Date: Mar. 16, 2017

(54) System and Method for Identifying User Habits

(71) Applicant: GeoCommerce Inc., Irvine, CA (US)

(72) Inventors: Jeff Sparrow, Tustin, CA (US); Mark Sullivan, Clovis, CA (US)

(21) Appl. No.: 15/271,023

(22) Filed: Sep. 20, 2016

Related U.S. Application Data
(63) Continuation of application No. PCT/US2015/021898, filed on Mar. 20, 2015.
(60) Provisional application No. 61/968,211, filed on Mar. 20, 2014.

(51) Int. Cl. G06Q 30/02

(52) U.S. Cl. CPC G06Q 30/0246; G06Q 30/0273

(57) ABSTRACT

A method for appending location data to behavior profiles, includes tracking a number of impressions for a user when the user is on-line, tracking a number of opportunities for the user when the user is on-line, calculating a cost associated with the opportunities for the user, and determining an index for the user to quantify a qualitative value of the user. Therefore, exemplary embodiments use information gathered and associated about a user to provide different decision propositions to the providers of targeted information.

### CROSS REFERENCE TO RELATED APPLICATIONS

This application claims priority to U.S. Provisional Application No. 61/968,211, filed Mar. 20, 2014, titled “On-Line Direct Response Platform,” which is incorporated by reference herein in its entirety. This Application is related to PCT International Application No. PCT/US15/21885, filed Mar. 20, 2015, and titled “System and Method for Identifying Users on a Network,” which is incorporated by reference herein.

### TECHNICAL FIELD

The present disclosure is directed toward methods and systems for qualitatively identifying a potential user from online activities.

### BACKGROUND

Traditionally, a user was viewed in isolation such that a single user was observed only while engaging in activities associated with a given company's domain. For example, when shopping, a user may be observed and logged as shopping for particular items on a given vendor's website. Other vendor's will similarly identify the consumer for looking for a particular good when the consumer navigates to their respective domain and performs the same or similar search on the item. However, all of the information available or obtained about a user may not be useful in isolation to the company receiving the data. Therefore, traditionally, vendors have been limited in engaging consumers based on limited actions particular to a given company. For example, a user may be provided advertisements or information specifically on search criteria they previously ran across multiple websites. However, the likelihood of the user to be an actual consumer of the, product is completely unknown.

Traditionally, a user is identified in isolation from one device to another, and/or related devices within a family, household, or location. For example, whenever a person navigated using their desktop, for example, at work, companies would use individual cookies to identify the user on that device. The cookies only identified the user with respect to that cookie saved on that machine. Therefore, as the user navigated from another desktop, for example from home, then a separate cookie was used to track that activity. The cookies were not related from one machine to another. As user's increase their dependency on multiple devices, such as smart phones, tablets, laptops, and desktops, identifying a single user across multiple platforms is generally only performed by having the user register and provide login or identifying information that is specific to the user and independent of the respective devices. However, such identification requires direct action by the user. Many actions of a user are not performed through a login or registration process. For example, if a user is merely browsing or searching for information, such as when shopping, the consumer may not want to log into respective websites, and the time and commitment is not beneficial to the user.

### BRIEF SUMMARY

Exemplary embodiments use information gathered and associated about a user to provide different decision propositions to the providers of targeted information. For example, the correlated information may relate the quality or quantity of daily impressions to a user based on their overall usage through one or more devices. Therefore, instead of an unfocused distribution of targeted information, such as when an unidentified user performs a search for a given product, the distribution of targeted information may instead identify the user, know their available impression time, and fully utilize the time in front of any one user. Thus, the distributer of targeted information is more efficiently in control of the information provided to any one user, or persons around the one user.

### BRIEF DESCRIPTION OF THE DRAWINGS

FIG. 1 illustrates an exemplary method for appending location data to behavior profiles while preserving user anonymity.

FIG. 2 illustrates an exemplary behavioral map that may be created about an on-line user based on observing information exchanges of the user during on-line transactions, and off-line public information.

FIG. 3 illustrates an exemplary visual representation of a spatial database that relates persistent and semi-persistent data objects of a user to a specific point by observing networked activities.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention, it should be understood that the drawings are diagrammatic and schematic representations of exemplary embodiments of the invention, and are not limiting of the present invention nor are they necessarily drawn to scale.

Embodiments described herein may use identified information about a user related over time from on-line and off-line activities and tiles to create and estimate a qualitative value that user. The qualitative value may be associated with a cost of acquisition for displaying an advertisement to that user, the appeal of that user to a third party, the propensity of the user to perform some act in response to an action or event. Exemplary embodiment may be used to qualitatively index or quantitatively assign a value to the quality of a user based on estimated habits of the user created from observance of previous behavior patterns.

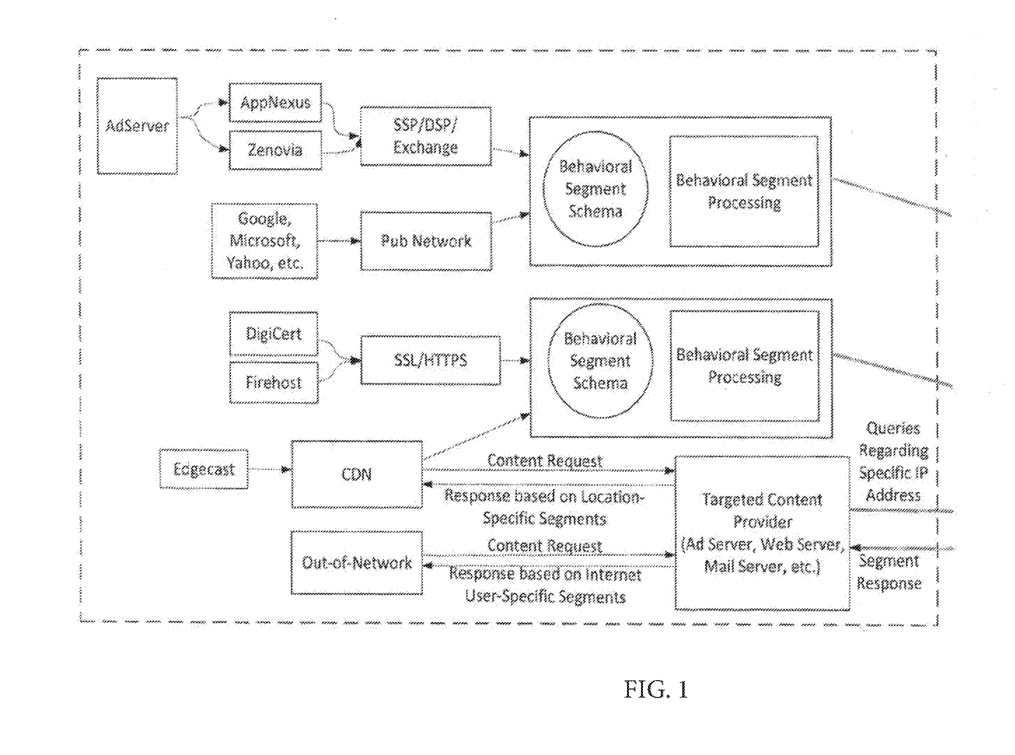

FIG. 1 illustrates an exemplary method for appending location data to behavior profiles while preserving user anonymity. Exemplary embodiments may be used to provide a quote engine to determine an average cost on a per impression basis for a given user. For example, embodiments described herein may be used to calculate a bid value necessary to provide a statistical likelihood to win an impression opportunity for a given user. Considerations may include, for example, the frequency of opportunities available for a given user.

In an exemplary embodiment, advertising auction data may be used to determine or inform the user index. Therefore, relevant information may include the ability to buy and sell advertisements opportunities for a given user. The information may include the frequency of opportunities or reach of opportunity. As illustrated, an ad server may be where an advertising asset is loaded or stored. The supply side publisher (SSP) owns available advertising space that is made available through the exchange to the demand side publisher (DSP). The DSP bids on the opportunity and supplies the ad from the adserver. The DSP may set parameters on a bid opportunity, such as a minimum bid, maximum bid, etc. if a bid is won, the content is posted by the ad server and the content is placed by the advertising network, such as AppNexus or Zenovia. As the ad is served from the ad server to the SSP, the communication includes the exchange, the SSP, a content delivery network, web server, and combinations thereof. When the ad is called, each contact may append information to the transaction that may be seen or logged by others along the transaction. Therefore, a relationship may be made for other ad placement requests made for the same IP address.

Publisher networks (such as Google, Yahoo, Microsoft) may require login credentials to identify a user. The publishers may share the login credential so that other websites can identify a user. For example, a user can supply a Google login credential to obtain access to other non-Google sites. The ad network therefore can supply from the use of cookies or IP address the frequency of interactions with a user. The publisher networks can track on-line activity to determine an amount of web exposure. Therefore, the frequency of interactions for a given on-line duration can be determined. The average cost of per impression for those interactions can also be determined.

Using data or users that have been authenticated such as by using publisher network logins or character recognition request or caption forms may be weighted or identified as more valuable encounters. Since an authentication process was engaged, the user is more likely an actual user to be engaged, instead of a virtual user that is merely using device resources. Because of the authentication, an additional assurance or protection can be assumed on the associations and confirmation of who the user is.

Other entities that touch the browser may also provide or capture behavioral information of a user or continued confirmation or association of a user to one or more known devices or IP addresses. For example, DigiCert when creating a secure browser connection uses a certificate and handshake between the browser and website. As the SSL is delivered, the IP address is also provided; on the browser side, a cache id is associated with the same IP address. Therefore, an association between the IP address and device can be confirmed, and the behavior of a user on the device can be tracked as associated with the same user. The cache ID can be used to determine a frequency of visits to the associated location or associate the destination to the user.

The content delivery network (CDN), such as Edgecase, may use space in the cache. The content delivery network can store session ids of interactions with specific websites, such that it can determine whether page reloads are necessary or whether stored history may be locally called. Because of the communication, a relationship between browser and IP address can be identified.

Out of network exchanges may be used to identify a user across devices. For example, as a user attempts to log into an application, such as Skype, the login may require a confirmation through a connection out of network or unrelated do the attempted exchange. For instance, when logging into Skype, a passcode may be sent to an email or mobile device. That passcode is then used to login. The multiple devices can then be related together. Another example may include, for example, Netflix in which a user may login across multiple devices. The multiple devices may therefore be related together. The related devices may then permit the behavioral patterns, impressions, or interactions across those devices to be aggregated into a total index value for the user.

Behavioral segment schema may be used to determine take the seen traffic and log any other information that may be desired about the user. For example, the session, operating system, browser, device, etc. may be of interest to provide additional behavioral characteristics to use in analyzing, assessing, or predicting the possible future behavior of the user. Therefore, any statistical correlation between the user and another attribute may be made. For example, an DSP may be interested in the type of device to determine whether an ad will be displayed appropriately. Therefore, to achieve the best impression with that user, the advertisement may be filtered and displayed on only desktops or mobile devices, or may be created to expand to the appropriate dimensions if supplied on one or the other. The correlations may be made to know what type of opportunities are available or to define the available opportunities. Therefore, better advertisements can he made.

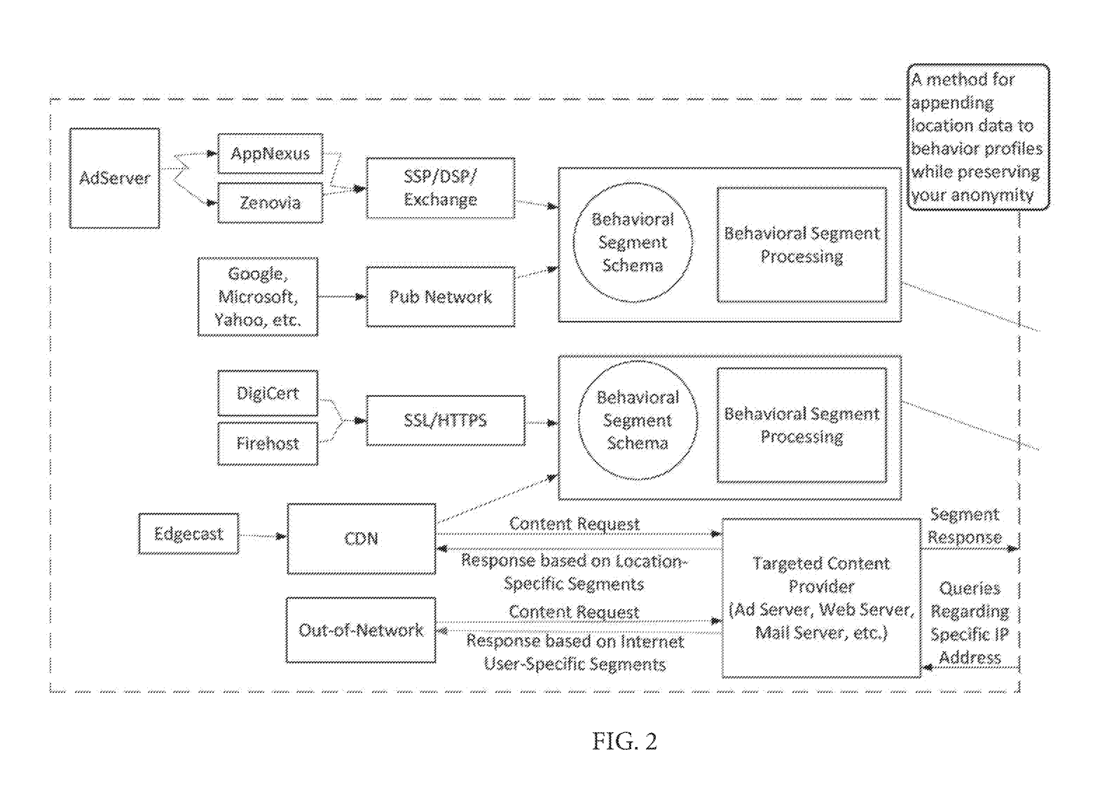

FIG. 2 illustrates an exemplary behavioral map that may be created about an on-line user based on observing information exchanges of the user during on-line transactions, and off-line public information. The behavioral map may be used to create or calculate one or more index value indicating a qualitative value of the user. The index value may be, for example a quote to achieve a number of impressions for that user. Conversely, if a user provides a budget to make impressions to that user, the index value may be used to determine or estimate a likely number of impressions for that user,

Exemplary embodiments may relate persistent or semi-persistent identifiers observed about a user during the user's on-line exchanges. The persistent or semi-persistent identifiers may be used to relate an IP address or other persistent or semi-persistent identifier to a physical address of the user. The physical address may be One or more addresses of the user and include locations defined in reference to a grid, locating system, in relation to a reference, or otherwise identifiable or describable position. For example, a physical address may be the present location of the user in terms of GPS coordinates or latitude/longitude coordinates. Physical address may also include postal address of locations frequented by the user. Physical address may include work or resident addresses.

In an exemplary embodiment, a method of identifying users by IP address and geographic locations permit location participation assessments for a given user. By relating various IP addresses of a single user to location information of that user, the location habits of the user can be observed. For example, a user may be related to multiple IP addresses of various devices, such as desk tops, smart phones, tablets, laptops, etc. As those IP addresses arc related to the single user, the location of those IP addresses can also be observed along with the time the user is active at those locations. Therefore, an exemplary embodiment may track and correlate physical addresses of a user along with the time and/or duration of those visits. Assumptions about the physical location may be made based on the correlated location and time persistency. For example, day parting, physical address frequency, and duration may also be used to determine additional data objects or attributes associated with a given physical address. Therefore, an address may be further identified or classified as a work or residential address.

For example, an IP address associated with the user at the daytime hours for an extended period of time can be associated with the person's work location, while an IP address and associated geographic location repeatedly used in the evening can be identified as a residence of the user. The specific location or establishment may also be known, such as if the user is signed onto a specific establishment's network to obtain connectivity. Therefore, a general location and/or specific residence identity may be known when a user connects to one or more networks. The physical location may be tracked with respect to time, day, duration, or combinations thereof and analyzed to make assumptions about the physical location. The day of the week, duration, and timing of the user's presence at the physical address can be used to identify the relationship of the physical location to the user, such as home, work. etc.

Other locations associated with the IP addresses of the user can be identified and logged to determine the user's transportation habits. In an exemplary embodiment, the driving patterns or available driving patterns can be identified between locations frequented by a user by locating the various IP addresses of the user at different locations. For example, if a user is sequentially located at different establishments for a certain amount of time and within an approximate amount of time related to the distance between those establishments, it can be conceived that the user was commuting between the establishments while not connected to a network or actively using a device for the time between connecting to the networks. Different commuting patterns or routes may be identified for the user between those locations. Therefore, generally, establishments along those routes may be interested in alerting the user to their presence. If a specific vendor is identified as frequented by the user, such as for example, a known coffee establishment, but alternative coffee or beverage establishments are within the commuting pattern of the user, then those establishments may identify the user and offer enticements, deals, or directed information at that user. Accordingly, the Physical address associated with the user may be used to determine behavioral patterns and/or propensities for products or services.

In an exemplary embodiment, the geographic locations associated with a user may also provide additional information for evaluating a user. Accordingly, a geographic location may be used to statistically assess whether a user may be of potential interest to a third party. In an exemplary embodiment, a physical address associated with the user, such as a home address, may be used to associate other likely demographic information about the user. Other demographic information may include likely household income, home value, education level, family status, political affiliation, etc. The demographic information may come from publically available correlations between residence and residential demographics. For example, if a user's residence location and/or work location can be determined, then when the user shops for a particular item, the likelihood that the user is a consumer of that item can be verified or statistically informed. For example, if a consumer is searching for a high end luxury vehicle with a substantial price tag, the user's residence and/or work location may provide general demographic information about the user to statistically assess whether the user is likely a purchaser of the vehicle or merely interested in viewing or researching such vehicles. Therefore, when a user searches for a particular product, the vendors or suppliers can assess whether the user is a likely consumer based on information associated with the user's location history,

In an exemplary embodiment, a method of identifying related devices to a single user or related users in a single residence or related people to a user may be achieved by observing semi-persistent or persistent identifiers in common with the user. For example, common devices may be identified by relating one or more persistent or semi-persistent identifiers that include and relate a physical address. The same physical address may be related and observed with respect to the on-line activities of other users. Therefore, a relationship can be assumed between those users. Therefore, co-workers and/or family or residence members may be identified as related through identifiers including a physical address in common with the user.

Exemplary embodiments described herein may relate different devices together through the same physical location. For example, when relating the mobile device through the household modem, the mobile device, such as a cell phone or tablet, is identified with a relationship to both the modem IP address of the residence as well as the street address of the residence. Therefore, for example, the mobile IP address may be related to the modem IP address, the postal address, latitude/longitude coordinates, and combinations thereof. Whenever a laptop, desktop, smart TV, or other device similarly connects through the same modem IP address, the device IP address of the respective devices can also be related to the mobile IP address though that same modem 1P address. Therefore, the entire or a substantial portion of the internet available devices of a given residence can be identified and related together.

Because each of the devices connected to a particular user or IP address are known, the patterns of where those devices go onto other networks can also be observed and related as well. From this information, the devices associated with particular users instead of related users can be distinguished or identified. For example, of all of the identified internet available devices fir a given residence, two of the devices may go to separate physical addresses during the day. Therefore, these two devices can be attributable to two different users within the household.

In an exemplary embodiment, a set of users or related user devices may be observed to provide comprehensive opportunities to engage a user. For related users, for example, multiple devices may be identified and related through a common IP address, such as the modem IP address of a wireless network. The activity on one or more devices may then be observed to create a comprehensive opportunity to present information to the users associated with the same residence, or residences adjacent thereto. For example, a first user may be engaged on a first mobile device but not provide any opportunity to receive information from an outside source, i.e. there are no ad impression opportunities available. However, a related second user may be engaged in an application, website, or other activity on a second device that does provide an opportunity to receive information from an outside source. Therefore, a residence or group of users related by geographic location may be provided a comprehensive information set from a provider depending on the opportunities presented by one or more users at the related geographic location. The user may therefore be qualitatively accessed based on quantity and kinds of impression opportunities.

For a single user across multiple devices, similar opportunities may be observed and/or identified. For example, an individual user may be related to multiple devices through the respective IP addresses. The various opportunities to reach the individual user may then be quantified or indexed, such that a single user can be contacted across multiple devices in multiple activities with the respective devices.

Exemplary embodiments may also identify and track impression opportunities to a user. The costs associated with an impression opportunity for a given user may therefore be observed and recorded. For any user, an index value of the quality and/or associated cost of the user may be calculated. In an exemplary embodiment, a user may provide a number of advertising impression opportunities. The opportunities may also be spread over a range of advertising spaces that range in cost. A second user may provide only a limited number of advertising impression opportunities. The opportunities may be, for example, higher in cost to display an advertisement. The first user may be assessed a lower cost for an impression opportunity because the opportunity can be taken on the lower cost sites frequented by the user. However, to get an impression opportunity to the second user, a higher cost will be incurred. In order to ensure an impression opportunity for the second user, an even higher price may be incurred as the number of impression opportunities is known to be low, so when an opportunity becomes available, a third party may pay a premium to ensure success. Accordingly, a quantitative value may be associated with a user to achieve a desired number of impression opportunities,

Exemplary embodiments may also identify and track engagement occurrences, such as when a user clicks on an advertisement or engages an impression opportunity. For any user, an index value of the quality of a user may be calculated based on the propensity of the user to engage or click on an impression. If a user does not engage impression opportunities, then the user's value may be decreased.

Exemplary embodiments may be used to provide a single index that provides behavioral information about the user. For example, the index may be used to identify the number of impressions, the number of engagements or opportunities, the number of click throughs, and average cost per impression, or combinations thereof for a given user with a single key. The index may be a rating of the user indicating the desirability of the user to win an impression opportunity. The index may therefore influence the bid value when an impression opportunity arises. For example, the index may indicate that a higher bid is necessary to engage a specific user because that user does not have as many opportunities or because the sites visited by that user have higher costs. Therefore, the cost of acquiring an impression to that user or achieving an opportunity is greater.

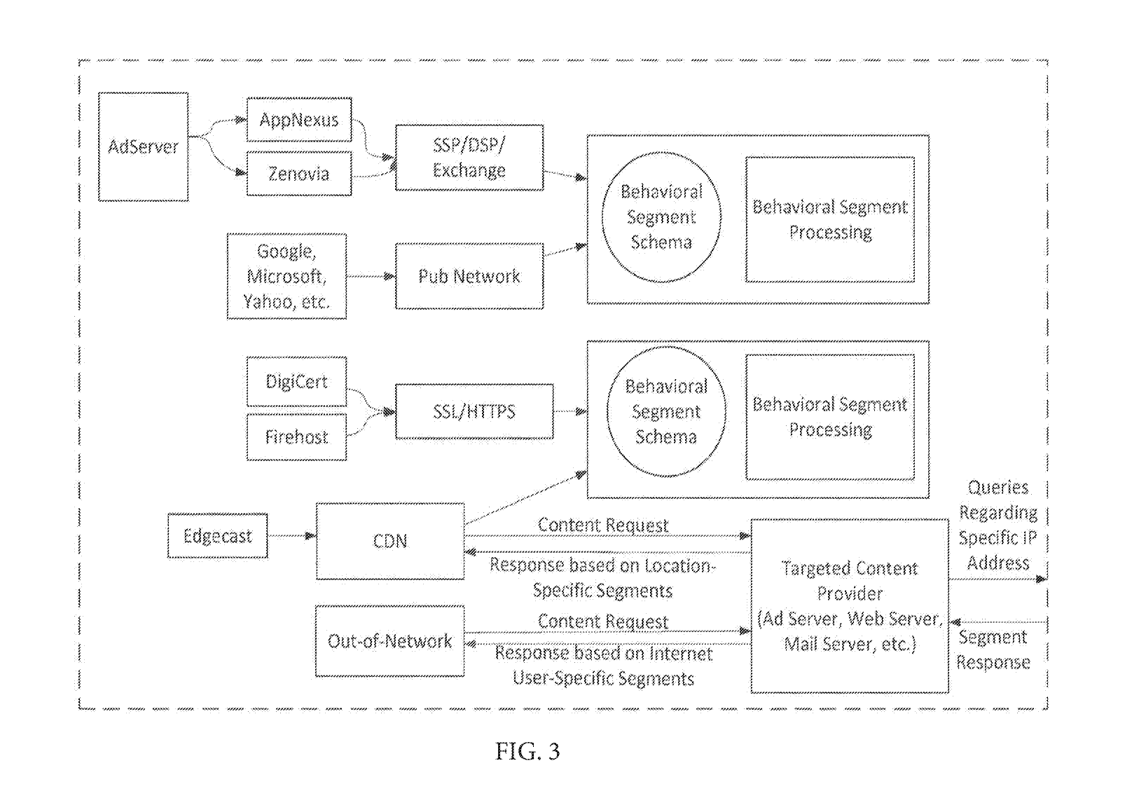

FIG. 3 illustrates exemplary semi-persistent and persistent identifiers that may be used to associate a user to a physical address. The unique URL 220, identifier token 222, and cache ID 210 may be associated together when the user engages a secure connection. The device IP address 212c is related to the street address 202 through the cookie value 206, when a user uses an auto-fill form of a website. Other unique set of persistent or semi-persistent identifiers may be tied to a specific device and used to create other data objects within the spatial database. For example, device ID 204 which uniquely identifies a device may be related to an IP address 212c and used to identify or relate other information pieces passed or logged with the device ID. A video card ID 218 may be related to a Device IP address 212c. Modem IP address 212a, mobile IP address 212b, and latitude/longitudinal of a mobile device may be related together when the mobile device connects to the modem. E-mail 214 and unique URL 208 may be related when a user launches a website from within an email.

Exemplary embodiments described herein may empower a third party to grow conversions and engagements by delivering more personalized messaging. Marketing to the masses makes people feel like they ace not valued. No one likes to be part of the crowd. People appreciate personal attention. They keep relationships that make them feel like someone who matters.

Now advertisers and businesses can take a much closer look at their most valuable customers, get to know their minds and motivations, and connect in a more meaningful way.

Exemplary embodiments described herein allow companies and advertisers to get to know real individuals, unique interact users within a household or business. Built on extensive data gathering and comprehensive analytics, exemplary customer intelligence algorithms described herein may be used to create a full view of the individuals who make up a target audience.

A company or advertiser may therefore learn more about individual customers, so the business can improve message relevance for higher conversion and stronger engagement. Embodiments described herein may enable better insight into who people are, so companies can build deeper relationships with their exact target audience. It starts with getting inside their thinking process, getting at what makes them who they are, making sense of what they do. Only after you put these pieces together can a company communicate on a more personal level.

Embodiments described herein allows a company to leverage accurate and verifiable customer data, without accessing personally identifiable information. A company can have the tools to continually refine their audience profiles, marketing message, and campaign strategies. Companies can create powerful audience segmentation that makes it possible to more directly target specific audience profiles. This precision intelligence gives companies what they need to put the right messages in front of the right people.
Gain real insights about real people
Improve message relevance and customer connection
Get higher conversion and stronger engagement
Easy to use for non-technical marketing managers
Highly tangled data for granular analysis
Customizable to your business objectives

Although embodiments of the invention may be described and illustrated herein in terms of relating an 1P address of a user to the user's physical address, it should be understood that embodiments of this invention are not so limited, but are additionally applicable to bridging a data relationship to any identifier of a user, device, related entity or object, or point. Furthermore, although embodiments of the invention may be described and illustrated herein in terms of marketing to a user, it should be understood that embodiments of the invention are also applicable to other internet applications, such as identifying users, identifying non-users, statistical observation and analysis, observing device movements, and identifying, observing, analyzing, and/or manipulating any number of user statistics, information, uses, habits, etc.

Embodiments described herein may he used for identifying a specific user on an Internet network through empirical observation of user location, public information, and user network actions. Exemplary systems and methods for relating such user information may be found in international Application No. PCT/US15/21885, filed Mar. 20, 2015, which is incorporated by reference herein.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A method for appending location data to behavior profiles, comprising:
tracking a number of impressions for a user when the user is on-line;
tracking a number of opportunities for the user when the user is on-line;
calculating a cost associated with the opportunities for the user; and
determining an index for the user to quantify a qualitative value of the user.

2. The method of claim 1, wherein the impressions comprise an availability to serve an advertisement to the user, and the opportunities is an actual occurrence of when an advertisement was served.

3. The method of claim 1, wherein the index corresponds to a cost of acquiring an opportunity to the user.
